(19) United States
(12) Patent Application Publication
(10) Pub. No.: US 2026/0194927 A1
(43) Pub. Date: Jul. 9, 2026

(54) TWO-STAGE PRESSURE REGULATOR FOR COMPRESSED GAS

(71) Applicant: Engineered Controls International, LLC, Elon, NC (US)

(72) Inventors: Guangbin Cao, Shanghai (CN); Yao Li, Shanghai (CN); Wen Fu, Simsbury, CT (US)

(21) Appl. No.: 19/135,682

(22) PCT Filed: Dec. 7, 2022
(86) PCT No.: PCT/CN2022/137173

§ 371 Date: Jun. 4, 2025

(51) Int. Cl. G05D 16/10

(52) U.S. Cl. CPC G05D 16/109

(57) ABSTRACT

Two-stage pressure regulators for compressed gas are disclosed. An example two-stage pressure regulator includes a body, an upstream piston, a seat assembly, and a downstream piston. The body defines an inlet, an outlet, a chamber and an upstream valve seat. The upstream piston is slidably positioned in the chamber adjacent the inlet. The upstream piston includes a first plug that is configured to engage the upstream valve seat in a first closed position and be disengaged from the upstream valve seat in a first open position. The seat assembly is housed in the chamber and includes a downstream valve seat. The downstream piston is slidably positioned in the chamber adjacent the outlet. The downstream piston includes a second plug that is configured to engage the downstream valve seat in a second closed position and be disengaged from the downstream valve seat in a second open position.

### TECHNICAL FIELD

This disclosure generally relates to regulators and, more particularly, to a two-stage pressure regulator for compressed gas.

### BACKGROUND

Pressure regulators are used to control a pressure of a fluid, such as a gas or a liquid, to a desired value. Some pressure regulators are double-stage regulators that include two regulators in series. The first of the regulators reduces the pressure of the fluid from a first level to a second level, and the second of the regulators reduces the pressure of the fluid from the second level to a third level. Some double-stage regulators include two safety valves, with each safety valve dedicated to a respective one of the regulators. Oftentimes, components of double-stage regulators are exposed to relatively great pressure and force levels that result in an undesirable amount of wear-and-tear of those components over time.

### SUMMARY

An example two-stage pressure regulator is disclosed herein. The two-stage pressure regulator includes a body defining an inlet, an outlet, and a chamber extending between the inlet and the outlet. The chamber includes an inlet section, an intermediate section, and an outlet section. The body includes an upstream valve seat adjacent the inlet. The two-stage pressure regulator includes an upstream piston slidably positioned in the chamber adjacent the inlet to separate the inlet section and the intermediate section of the chamber. The upstream piston includes a first plug that is configured to engage the upstream valve seat in a first closed position. The first plug is configured to be disengaged from the upstream valve seat in a first open position to enable compressed gas to flow from the inlet section and to the intermediate section. The two-stage pressure regulator includes a seat assembly housed in the chamber and fixed to the body. The seat assembly includes a downstream valve seat. The two-stage pressure regulator includes a downstream piston slidably positioned in the chamber adjacent the outlet to separate the intermediate section and the outlet section of the chamber. The downstream piston includes a second plug that is configured to engage the downstream valve seat in a second closed position. The second plug is configured to be disengaged from the downstream valve seat in a second open position to enable the compressed gas to flow from the intermediate section and to the outlet section.

### BRIEF DESCRIPTION OF THE DRAWINGS

FIG. 1 is a perspective view of an example pressure regulator in accordance with the teachings herein.

FIG. 2 is a side view of the pressure regulator of FIG. 1.

FIG. 3 is a cross-sectional view along a first plane of the pressure regulator of FIG. 1 in an open state.

FIG. 4 is a cross-sectional view along a second plane, which is perpendicular to the first plane, of the pressure regulator of FIG. 1 in an intermediate state.

FIG. 5 is a cross-sectional view of a second-stage piston of the pressure regulator of FIG. 1.

FIG. 6 is a cross-sectional view of a valve seat assembly of FIG. 1.

FIG. 7 is a cross-sectional view of a first-stage piston of the pressure regulator of FIG. 1.

FIG. 8 is a cross-sectional view along the second plane of FIG. 4 of the pressure regulator of FIG. 1 in a closed state.

FIG. 9 is an expanded view of cross-sectional view along the second plane of FIG. 4 of the second-stage piston of FIG. 7 in a closed position.

FIG. 10 is a further expanded view of cross-sectional view of the second-stage piston of FIG. 5 and the valve seat assembly of FIG. 6 when the second-stage piston of FIG. 7 is in a closed position.

FIG. 11 is an expanded view of cross-sectional view along the second plane of FIG. 4 of the second-stage piston of FIG. 7 in an open position.

FIG. 12 is an expanded cross-sectional view along the second plane of FIG. 4 of the first-stage piston of FIG. 7 in a closed position.

FIG. 13 is an expanded cross-sectional view along the second plane of FIG. 4 of the first-stage piston of FIG. 7 in an open position.

FIG. 14A is a front view of a safety relief valve of the pressure regulator of FIG. 1.

FIG. 14B is a cross-sectional view of the safety relief valve of FIG. 14A.

FIGS. 15A-15D depict a sequence of opening the safety relief valve of FIGS. 14A and 14B.

FIG. 16 is a cross-sectional view of the pressure regulator of FIG. 1 with sealing caps.

### DETAILED DESCRIPTION OF THE DRAWINGS

The description that follows describes, illustrates and exemplifies one or more embodiments of the present invention in accordance with its principles. This description is not provided to limit the invention to the embodiments described herein, but rather to explain and teach the principles of the invention in order to enable one of ordinary skill in the art to understand these principles and, with that understanding, be able to apply them to practice not only the embodiments described herein, but also other embodiments that may come to mind in accordance with these principles. The present specification is intended to be taken as a whole and interpreted in accordance with the principles of the present invention as taught herein and understood by one of ordinary skill in the art.

The scope of the present invention is intended to cover all such embodiments that may fall within the scope of the appended claims, either literally or under the doctrine of equivalents. The specification describes exemplary embodiments which are not intended to limit the claims or the claimed inventions. Features described in the specification, but not recited in the claims, are not intended to limit the claims.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose.

Some features may be described using relative terms such as top, bottom, vertical, rightward, leftward, etc. It should be appreciated that such relative terms are only for reference with respect to the appended drawings. These relative terms are not meant to limit the disclosed embodiments.

Example pressure regulators disclosed herein include two stages. The first stage is configured to reduce the pressure of the compressed gas (e.g., hydrogen, nitrogen, oxygen, argon, compressed natural gas, compressed air, etc.) from an upstream pressure to an intermediate pressure, and the second stage is configured to further reduce the intermediate pressure to a downstream pressure (e.g., about 10 bar). The first stage is configured to significantly reduce the fluid pressure (e.g., from 700 bar to about 50 bar) to enable the second stage to reduce the fluid pressure in a more precise and accurate manner (e.g., to about 10 bar).

In some examples, the first stage is configured to significantly reduce the fluid pressure to protect downstream components from undesirable levels of wear-and-tear. In some examples, the pressure regulator includes a spring for a piston of the second stage. An operator may adjust the position of such a spring to adjust the final fluid pressure at which the fluid exits the pressure regulator. In some examples, the pressure regulator includes a spring for a valve seat of the second stage. Such a spring is configured to compress when the piston of the second stage engages the valve seat to reduce wear on the valve seat over time.

In some examples, the pressure regulator includes a single vent that is configured to vent fluid that may have escaped from a plurality of different sections (e.g., an inlet section, an outlet section, an intermediate section) of the pressure regulator. Additionally, in some examples, the pressure regulator includes a safety relief valve that is configured to open when pressure in an outlet section is greater than a predefined pressure threshold and/or when an operator manually operates the safety relief valve.

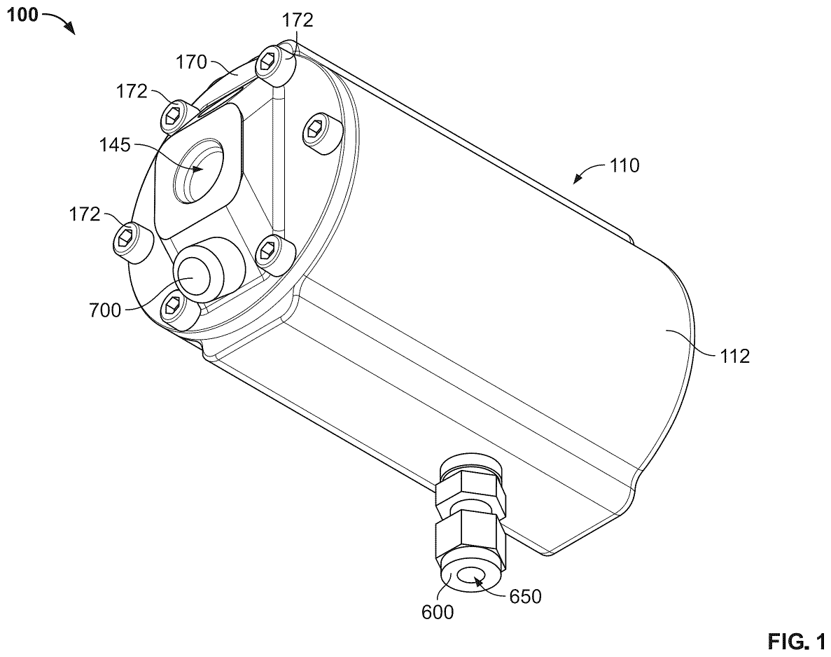

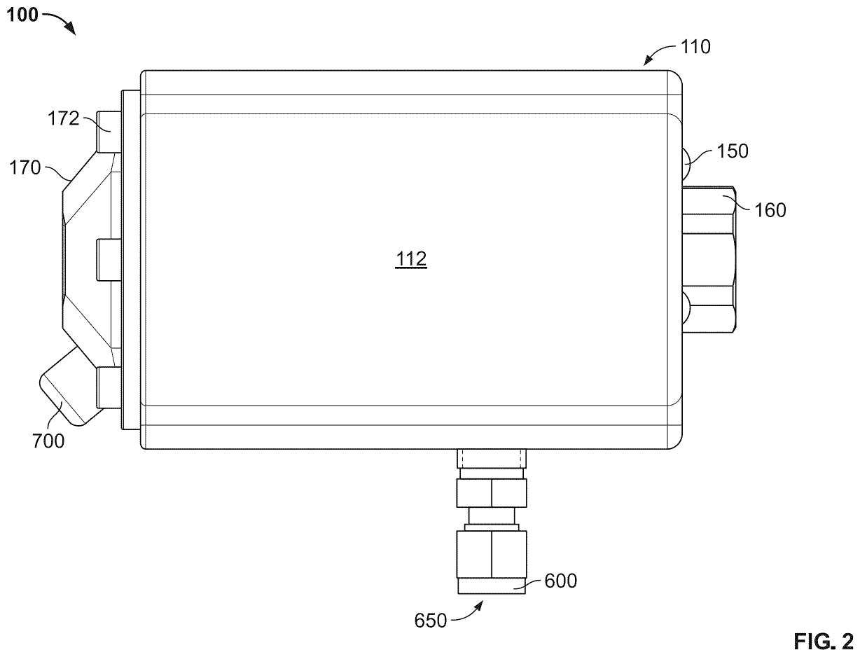

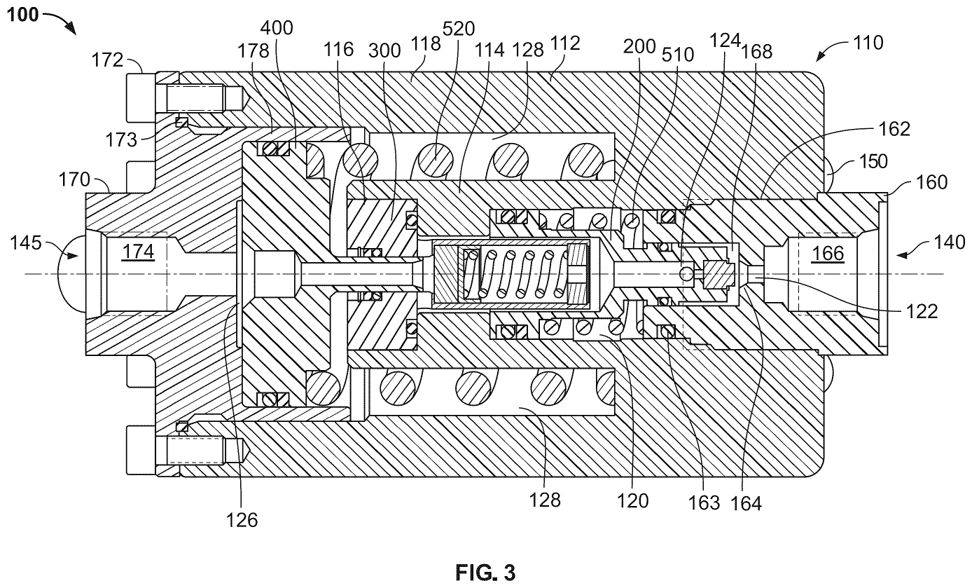

Turning to the figures, FIGS. 1-2 depict an exterior of an example of pressure regulator 100 as disclosed herein. Pressure regulator 100 includes body 110. Body 110 includes main body 112, inlet body 160, and outlet body 170. As disclosed below in greater detail, body 110 defines chamber 120 (FIGS. 3-4 and 8) in which flow-control components are housed to control flow of compressed gas, such as hydrogen, through body 110.

Inlet body 160 is coupled to a first end (also referred to as “inlet end” and “upstream end”) of main body 112 and defines inlet 140 (FIGS. 3-4 and 12-13) of chamber 120. For example, inlet body 160 includes threads (e.g., threads 162 of FIG. 3) that are threadably received by threads (e.g., inner threads) of main body 112 to threadably couple to the first end of main body 112. Pressure regulator 100 includes one or more threaded posts 150 that are positioned along the first end of main body 112. In the illustrated example, pressure regulator 100 includes three threaded posts 150. As disclosed below in greater detail, threaded posts 150 extend into and are threadably received by main body 112 to adjust a biasing force of spring 520 (FIGS. 3-4, 9, and 11), which, in turn, adjusts operation of one of two stages of pressure regulator 100.

Outlet body 170 is coupled to a second end (also referred to as “outlet end” and “downstream end”) of main body 112 and defines outlet 145 of chamber 120. The second end of main body 112 is opposite the first end such that outlet body 170 is opposite inlet body 160. Body 110 includes one or more fasteners 172 to couple outlet body 170 to the second end of main body 112.

In the illustrated example, body 110 includes vent fitting 600 that is coupled to main body 112. As disclosed below in greater detail, vent fitting 600 defines vent 650 that is configured to vent gas (e.g., hydrogen gas) that may have leaked from chamber 120 of body 110. For example, vent 650 is configured to vent hydrogen gas, which is highly flammable, into an exhaust system to dissipate in a safe manner. Pressure regulator 100 also includes safety relief valve 700 that is coupled to outlet body 170 of body 110. Safety relief valve 700 is configured to open when downstream pressure increases above a predetermined threshold. When open, safety relief valve 700 directs gas (e.g., hydrogen gas) from outlet 145 and to vent 650 to reduce the downstream pressure by dissipating some of the gas (e.g., hydrogen gas) into the environment.

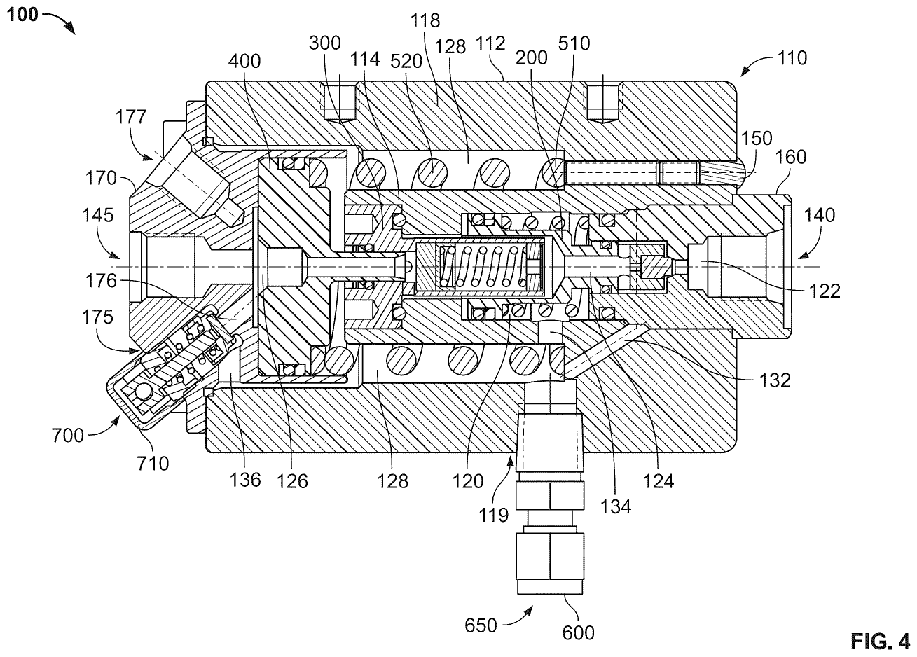

FIGS. 3-4 depict cross-sectional views of pressure regulator 100. In particular, FIG. 3 is a cross-sectional view of pressure regulator 100 along a first plane when pressure regulator 100 is in an open state, and FIG. 4 is a cross-sectional view of pressure regulator 100 along a second plane that is perpendicular to the first plane when pressure regulator 100 is in an intermediate state. Piston 200 is in a first open position and piston 400 is in a second open position when pressure regulator 100 is in the open state, and piston 200 is in a first closed position and piston 400 is in the second open position when pressure regulator 100 is in the intermediate state. Intermediate section 124 is defined by piston 200, seat assembly 300, and body 110. More specifically, in the illustrated example, intermediate section 124 is defined by piston 200, seat assembly 300, valve seat 164 of inlet body 160, and inner wall 114 of main body 112.

In the illustrated example, body 110 defines chamber 120. Body 110 defines inlet 140 on a first side (also referred to as “inlet side” and “upstream side”) of body 110 and defines outlet 145 on an opposing second side (also referred to as “outlet side” and “downstream side”) of body 110. Chamber 120 extends between and fluidly connects inlet 140 and outlet 145. Body 110 includes main body 112 that defines chamber 120.

Body 110 includes inlet body 160 (also referred to as “inlet-side body” and “upstream-side body”) that is coupled to the first side of main body 112 and defines inlet 140 of pressure regulator 100. As shown in FIG. 3, inlet body 160 is coupled to the first side of main body 112 via threads 162. A seal 163 (e.g., an O-ring) extends between and sealingly engages inlet body 160 and main body 112 to form a sealed connection between inlet body 160 and main body 112. Inlet body 160 includes valve seat 164 (also referred to as “first valve seat,” “first-stage valve seat,” and “upstream valve seat”) adjacent inlet 140 and defines chambers 166, 168 that are separated by valve seat 164. Chamber 166 (also referred to as “first inlet chamber”) is configured to receive compressed gas, such as hydrogen, from a source, and chamber 168 (also referred to as “second inlet chamber”) is configured to slidably receive a portion of piston 200. Chamber 166 and chamber 168 are in fluid communication when plug 250 of piston 200 is disengaged from valve seat 164.

Body 110 includes outlet body 170 (also referred to as “outlet-side body,” and “downstream-side body”) that is coupled to the second side of main body 112 and defines outlet 145 of pressure regulator 100. In the illustrated example, outlet body 170 is coupled to the second side of main body 112 via fasteners 172. For example, fasteners 172 are threaded fasteners that extend through outlet body 170 and are threadably received by main body 112 to fasten outlet body 170 to main body 112. A seal 173 (e.g., a gasket) extends between and sealingly engages outlet body 170 and main body 112 to form a sealed connection between outlet body 170 and main body 112. As shown in FIG. 3, outlet body 170 defines chamber 174 (also referred to as “outlet chamber”) that is configured to be in fluid communication and provide compressed gas (e.g., hydrogen) downstream of pressure regulator 100. Outlet body 170 also includes an inner wall 178 that extends into chamber 120 and engages outer wall 118 of main body 112.

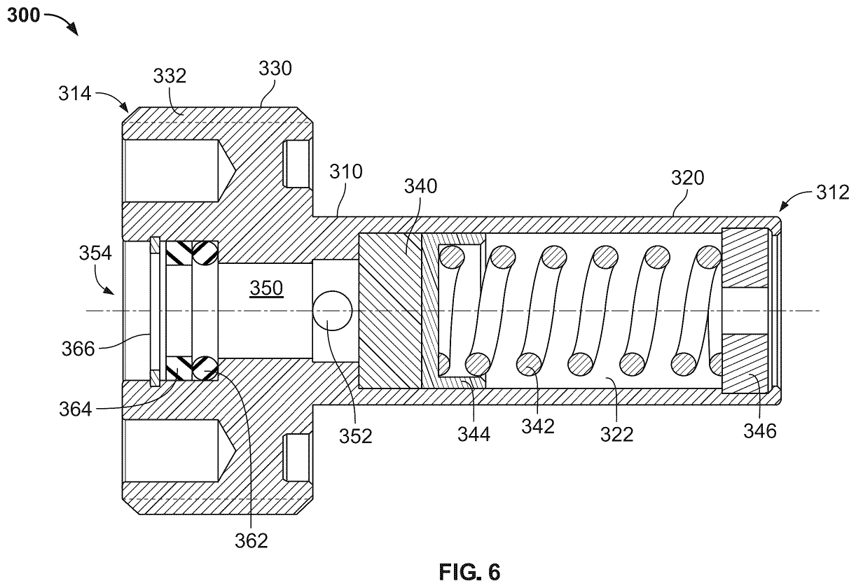

Pressure regulator 100 of illustrated example is a two-stage pressure regulator. Pressure regulator 100 includes piston 200, seat assembly 300, and piston 400 that are housed in chamber 120. Piston 200 (also referred to as “first piston,” “first-stage piston,” and “upstream piston”) is configured to slidably engage valve seat 164 of body 110 to operate a first stage of the two-stage pressure regulator. Piston 400 (also referred to as “second piston,” “second-stage” piston,” and “downstream piston”) is configured to slidably engage valve seat 340 (FIG. 6) of seat assembly 300 to operate a second stage of the two-stage pressure regulator.

As disclosed below in greater detail, piston 400 of the second stage is configured to open before piston 200 of the first stage. The first stage is configured to reduce the pressure of the compressed gas, such as hydrogen, from an upstream pressure (e.g., about 700 bar) to an intermediate pressure (e.g., about 50 bar), and the second stage is configured to further reduce the intermediate pressure to a downstream pressure (e.g., about 10 bar). The first stage is configured to significantly reduce the fluid pressure (e.g., from 700 bar to about 10 bar) to enable the second stage to reduce the fluid pressure in a more precise and accurate manner (e.g., to about 10 bar).

As shown in FIGS. 3-4, seat assembly 300 is housed in chamber 120 and fixed to body 110. Seat assembly 300 is fixed to inner wall 114 of main body 112 that at least partially defines chamber 120. In the illustrated example, seat assembly 300 is fixed to inner wall 114 via threads 116. Piston 200 is slidably positioned in chamber 120 adjacent inlet 140 and between seat assembly 300 and inlet body 160. Piston 400 is slidably positioned in chamber 120 adjacent outlet 145 and between seat assembly 300 and outlet body 170. Piston 200 is configured to slide between seat assembly 300 and inlet body 160 along the longitudinal axis of body 110 to open and close the first stage of operation of pressure regulator 100, and piston 400 is configured to slide between seat assembly 300 and outlet body 170 along a longitudinal axis of body 110 to open and close the second stage of operation of pressure regulator 100.

Pressure regulator 100 includes spring 510 (also referred to as “first spring” and “first-stage spring”) to bias piston 200 toward a respective open position and spring 520 (also referred to as “second spring” and “second-stage spring”) to bias piston 400 toward a respective open position. In the illustrated example, spring 510 extends between and engages piston 200 and inlet body 160 in chamber 120 of body 110 to bias the piston 200 toward the respective open position. Spring 520 is housed in chamber 120 and positioned radially between inner wall 114 and outer wall 118 of main body 112. Spring 520 extends between and engages piston 400 and main body 112 of body 110 to bias the piston 400 toward the respective open position.

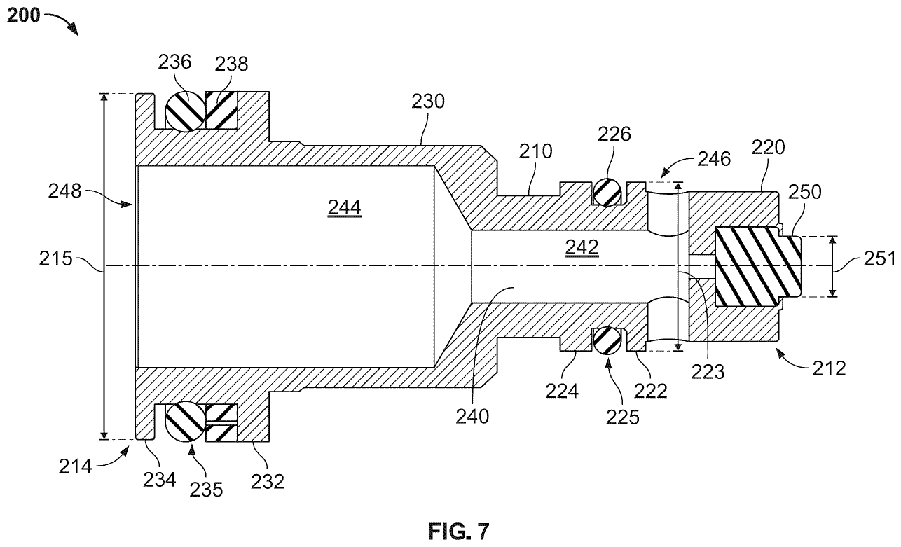

Body 110 includes main body 112, inlet body 160, and outlet body 170. Chamber 120 is defined by body 110 and is segmented into a plurality of sections. As shown in FIGS. 3-4, chamber 120 includes inlet section 122, intermediate section 124, and outlet section 126. Inlet section 122 extends from inlet 140 to valve seat 164, intermediate section 124 extends from valve seat 164 to valve seat 340, and outlet section 126 extends from valve seat 340 to outlet 145. Inlet section 122 is defined by body 110 and piston 200. More specifically, in the illustrated example, inlet section 122 is defined by inlet body 160 of body 110 and plug 250 (FIG. 7) of piston 200. Intermediate section 124 is defined by piston 200, seat assembly 300, and body 110. More specifically, in the illustrated example, intermediate section 124 is defined by piston 200, seat assembly 300, valve seat 164 of inlet body 160, and inner wall 114 of main body 112. Outlet section 126 is defined by piston 400 and body 110. More specifically, in the illustrated example, outlet section 126 is defined by piston 400 and outlet body 170.

Inlet section 122 and intermediate section 124 are in fluid communication with each based on the position of piston 200. If piston 200 is in the respective closed position (also referred to as the “first closed position” and “the first-stage closed position”), inlet section 122 and intermediate section 124 are fluidly separated from each other via piston 200. If piston 200 is in the respective open position (also referred to as the “first open position” and “the first-stage open position”), inlet section 122 and intermediate section 124 are fluidly connected to each other such that compressed gas is able to flow from inlet section 122 and into intermediate section 124.

Outlet section 126 and intermediate section 124 are in fluid communication with each based on the position of piston 400. If piston 400 is in the respective closed position (also referred to as the “second closed position” and “the second-stage closed position”), outlet section 126 and intermediate section 124 are fluidly separated from each other via piston 400. If piston 400 is in the respective open position (also referred to as the “second open position” and “the second-stage open position”), outlet section 126 and intermediate section 124 are fluidly connected to each other such that compressed gas is able to flow from intermediate section 124 and into outlet section 126.

Chamber 120 of the illustrated example also includes vent section 128. Vent section 128 is defined by body 110 and piston 400. More specifically, in the illustrated example, vent section 128 is defined by inner wall 114 and outer wall 118 of main body 112, outlet body 170, and piston 400. Body 110 also defines vent 650 that is in fluid communication with vent section 128. Vent 650 is formed by vent port 119 and/or vent fitting 600. As illustrated in FIG. 4, outer wall 118 of main body 112 defines vent port 119, and vent fitting 600 of body 110 is sealingly positioned in vent port 119. In turn, vent port 119 defines vent 650 for vent section 128 of chamber 120. In other examples, pressure regulator 100 includes no vent fitting 600 such that vent port 119 defines vent 650 for vent section 128.

Vent section 128 is fluidly connected to vent pathways 132, 134, 136. Vent 650, vent section 128 and vent pathways 132, 134, 136 are arranged and fluidly connected to each other such that vent 650 is able to vent fluid that may have leaked from a plurality of different sections from chamber 120. That is, pressure regulator 100 of illustrated example includes only one vent 650, which is capable of safely venting fluid that may have leaked from a number of different source points.

Vent pathway 132 (also referred to as “outlet vent pathway”) is defined by main body 112 of body 110. Vent pathway 132 extends from vent section 128 to a portion of inlet body 160 between threads 162 and seal 163. While threads 162 and seal 163 are configured to form a sealed connection between inlet body 160 and main body 112, vent pathway 132 is configured to direct any fluid that may have leaked between that connection to vent section 128 and, in turn, through vent 165 and out to the environment for safe dissipation.

Vent pathway 134 (also referred to as “intermediate vent pathway”) is defined by inner wall 114 of main body 112. Vent pathway 134 extends from vent section 128 to a portion of chamber 120 that is adjacent seat assembly 300 and located between seal 163, seal 226 (FIG. 7), and seal 236 (FIG. 7). While seal 163 is configured to form a sealed connection between inlet body 160 and main body 112 and seals 226, 236 are configured to form a sealed connection between seat assembly 300 and body 110, vent pathway 134 is configured to direct any fluid that may have leaked between those connections to vent section 128 and, in turn, through vent 165 and out to the environment for safe dissipation.

Vent pathway 136 (also referred to as “outlet vent pathway”) is defined by outlet body 170 and outer wall 118 of main body 112. Vent pathway 136 extends from vent section 128 to (1) safety relief valve 700 and (2) seal 173 located between outlet body 170 and main body 112. While safety relief valve 700 and seal 173 are configured to form a sealed connection with outlet body 170, vent pathway 136 is configured to direct any fluid that may have leaked to vent section 128 and, in turn, through vent 165 and out to the environment for safe dissipation.

As shown in FIG. 4, safety relief valve 700 is partially housed in valve chamber 175. Outlet body 170 defines valve chamber 175, relief pathway 176, and vent pathway 136 (also referred to as “outlet vent pathway”). Valve chamber 175 is connected to both relief pathway 176 and vent pathway 136. When outlet body 170 is coupled to main body 112, relief pathway 176 is fluidly connected to outlet section 126 of chamber 120 and vent pathway 136 is fluidly connected to vent section 128 of chamber 120. As disclosed below in greater detail, when safety relief valve 700 is in a closed position, safety relief valve 700 fluidly disconnects vent pathway 136 and vent section 128 such that compressed gas in outlet section 126 is prevented from entering vent section 128. When safety relief valve 700 is in a closed position, safety relief valve 700 fluidly connects vent pathway 136 and vent section 128 via valve chamber 175 to permit compressed gas to flow from outlet section 126 to vent section 128. Safety relief valve 700 is configured to open when pressure within outlet section 126 is greater than a predetermined threshold. By opening and directing some compressed gas into vent section 128 and out through vent 650, safety relief valve 700 is able to reduce the downstream pressure to be less than the predetermined threshold.

Outlet body 170 includes sensor chamber 177 for housing a sensor configured to monitor a pressure of the compressed gas in outlet section 126 of chamber 120. Prior to inserting the pressure sensor in sensor chamber 177, a pathway is formed in outlet body 170 (e.g., via drilling) that connects sensor chamber 177 to outlet section 126 to enable the pressure sensor to monitor the pressure of the compressed gas in outlet section 126.

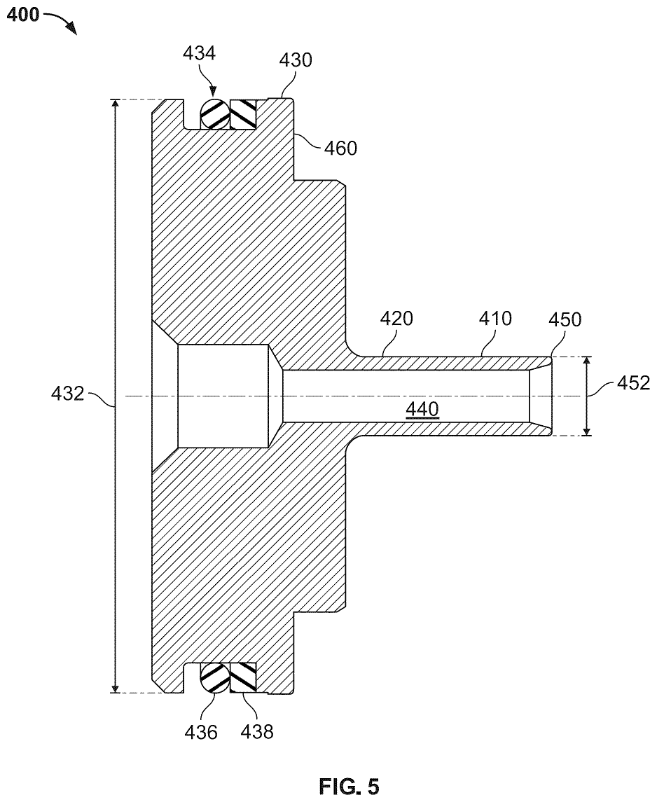

FIG. 5 is a cross-sectional view of piston 400 that includes piston body 410. Piston body 410 (also referred to as “second piston body,” “second-stage piston body,” and “downstream piston body”) includes a sections 420, 430 that are integrally formed together. Section 420 (also referred to as “first section”) is hollow, has a substantially cylindrical shape, and is adjacent a first end of piston body 410. Section 430 is hollow, has a substantially cylindrical shape, and is adjacent an opposing second end of piston body 410. Piston body 410 defines a flow path 440 that extends along a longitudinal axis of piston body 410. Flow path 440 extends a length of section 420 and a length of section 430. Flow path 440, chamber 174 and relief pathway 176 of outlet body 170, and a cavity formed by inner wall 178 of outlet body 170 form outlet section 126 of chamber 120.

Piston 400 includes plug 450 (also referred to as “second plug,” “second-stage plug,” and “downstream plug”). In the illustrated example, piston body 410 defines plug 450. In particular, plug 450 is defined at a distal end of section 420 of piston body 410. Plug 450 has diameter 452 and a corresponding cross-sectional area. Plug 450 is configured to sealingly engage and disengage valve seat 340 of seat assembly 300 as piston 400 transitions between the second closed position and the second open position, respectively.

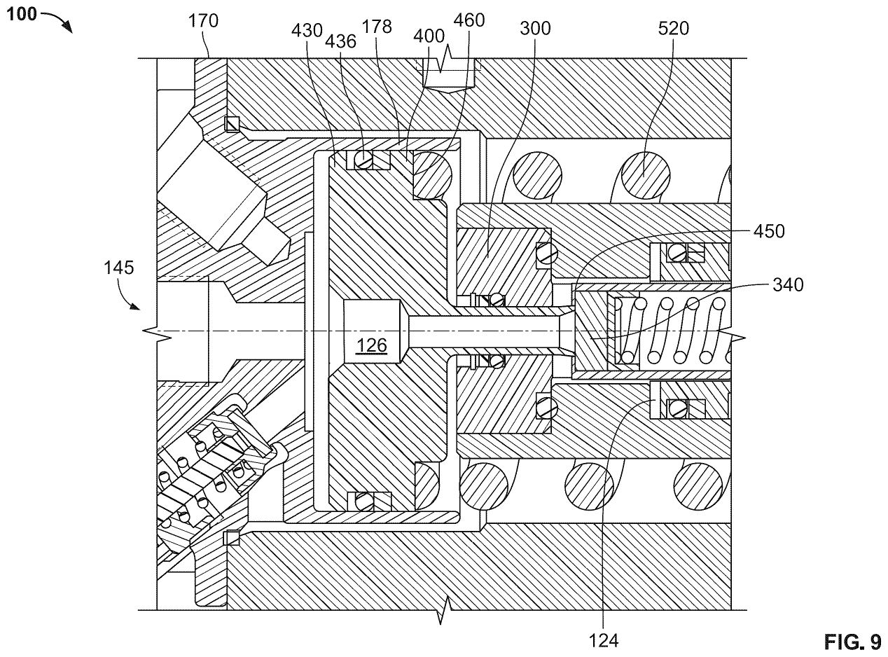

Section 430 has diameter 432 and a corresponding cross-sectional area. An outer radial end of section 430 defines groove 434 in which seal 436 and washer 438 are housed. Seal 436 (e.g., an O-ring) is configured to form a sealed connection between piston 400 and outlet body 170. As shown in FIG. 9, seal 436 sealingly engages section 430 of piston 400 and inner wall 178 of outlet body 170 to form the sealed connection. Returning to FIG. 5, washer 438 is configured to engage seal 436 to maintain a position of seal 436 within groove 434. Section 430 of the illustrated example also forms spring seat 460. Spring seat 460 is configured to enable an end of spring 520 (FIG. 9) to securely engage piston 400, thereby enabling spring 520 to bias piston 400 to the second open position.

FIG. 6 is a cross-sectional view of seat assembly 300 that includes body 310 (also referred to as “seat assembly body” and “seat body”). Body 310 includes a sections 320, 330 that are integrally formed together. Body 310 is fixed to body 110 via threads 332 located on a radially outer surface of section 330. Section 320 (also referred to as “first section”) is hollow, has a substantially cylindrical shape, and is positioned adjacent first end 312 of body 310. Section 330 (also referred to as “second section”) is hollow, has a substantially cylindrical shape, and is positioned adjacent second end 314 of body 310.

Section 320 defines a seat chamber 322 in which valve seat 340 of seat assembly 300 is securely housed. In the illustrated example, valve seat 340 is a seat disc. Seat assembly 300 also includes spring 342 (also referred to as “seat spring”), spring holder 344, and spring plug 346 that are housed in seat chamber 322. Valve seat 340 (also referred to as “second valve seat,” “second-stage valve seat,” and “downstream valve seat”) is positioned at a proximal end of seat chamber 322 adjacent section 330. Spring holder 344 engages spring 342, and spring plug 346 is positioned adjacent a distal end of seat chamber 322. Spring 342 extends between and engages spring holder 344 and spring plug 346 to securely press valve seat 340 in place at the proximal end of seat chamber 322.

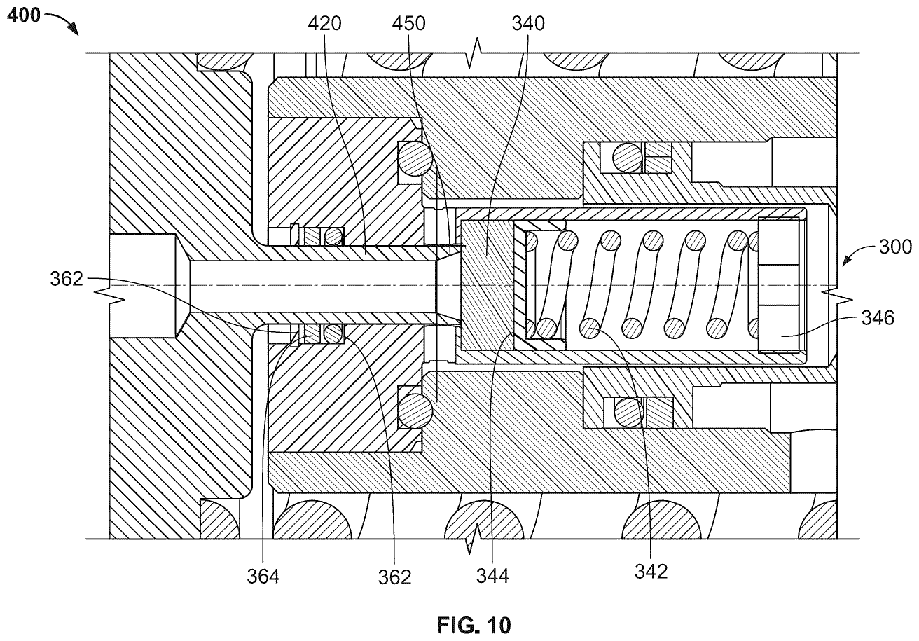

In some instances, plug 450 of piston 400 may suddenly close and, in turn, edges of plug 450 may punch valve seat 340. FIG. 10 is an expanded cross-sectional view of the plug 450 engaging valve seat 340. When this occurs, spring 342 compresses and enables valve seat 340 to move in a direction toward inlet 140, thereby reducing the risk of valve seat 340 wearing and/or cracking that may otherwise occur over time if the position of valve seat 340 were fixed. When piston 400 subsequently transitions back to the second open position, spring 342 is configured to expand to push valve seat 340 back toward outlet 145.

Returning to FIG. 6, body 310 of seat assembly 300 defines flow path 350. In the illustrated example, section 330 and a portion of section 320 define flow path 350. Flow path 350 extends along a longitudinal axis of body 310 between valve seat 340 and outlet 354 of flow path 350. Body 310 defines outlet 354 at second end 314 and defines inlet 352 adjacent valve seat 340. In the illustrated example, inlet 352 is formed by one or more holes defined by body 310.

Intermediate section 124 of chamber 120 is partially formed by an outer surface of section 320 and an adjacent portion of inner wall 114 of main body 112 such that compressed gas flows around outer surface of section 320 of body 310 when in intermediate section 124 of chamber 120. When plug 450 of piston 400 engages valve seat 340 in the second closed position, piston 400 covers inlet 352 to fluidly disconnect intermediate section from outlet section 126. In contract, when plug 450 of piston 400 is disengaged from valve seat 340 in the second open position, inlet 352 is at least partially uncovered by piston 400 to fluidly connect intermediate section to outlet section 126.

As clearly shown in FIGS. 3-4 and 8, first end 312 and/or a portion of section 320 of body 310 is received by an opening of piston 200 (e.g., outlet 248 of piston 200 of FIG. 7) such that seat assembly 300 is partially nested in piston 200. Second end 314 and/or a portion of section 330 of body 310 defines an opening (e.g., outlet 354) that slidably receives piston 400 such that piston 400 is partially nested in seat assembly 300. Piston 400 is partially nested in seat assembly 300 and seat assembly 300 is partially nested in piston 200 such that pressure regulator 100 has a compact footprint. Returning to FIG. 6, seat assembly 300 includes seal 362 (e.g., an O-ring), washer 364, and retainer ring 366 that are positioned in flow path 350. As most clearly shown in FIG. 10, seal 362 is configured to form a sealed connection between seat assembly 300 and piston 400. Washer 364 and retainer ring 366 are configured to retain seal 362 in place.

Turning to FIG. 7, a cross-sectional view of piston 200 is depicted. Piston 200 includes piston body 210 (also referred to as “first piston body,” “first-stage piston body,” and “upstream piston body”). Piston body 210 includes a sections 220, 230 that are integrally formed together. Section 220 (also referred to as “first section”) has a substantially cylindrical shape and is adjacent a first end 212 of piston body 210. Section 230 (also referred to as “second section”) is hollow, has a substantially cylindrical shape, and is adjacent an opposing second end 214 of piston body 210. Piston body 410 defines a flow path 240 that extends along a longitudinal axis of piston body 410 between section 220 and section 230. Flow path 240 extends a length of section 230 and a portion of a length of section 220. Flow path 240 includes first section 242 defined by section 220 of piston body 210 and second section 244 defined by section 230 of piston body 210. Section 220 of piston body 210 defines inlet 246 adjacent first end 212, and section 230 of piston body 210 defines outlet 248 at second end 214. In the illustrated example, inlet 246 is formed by one or more holes defined by piston body 210.

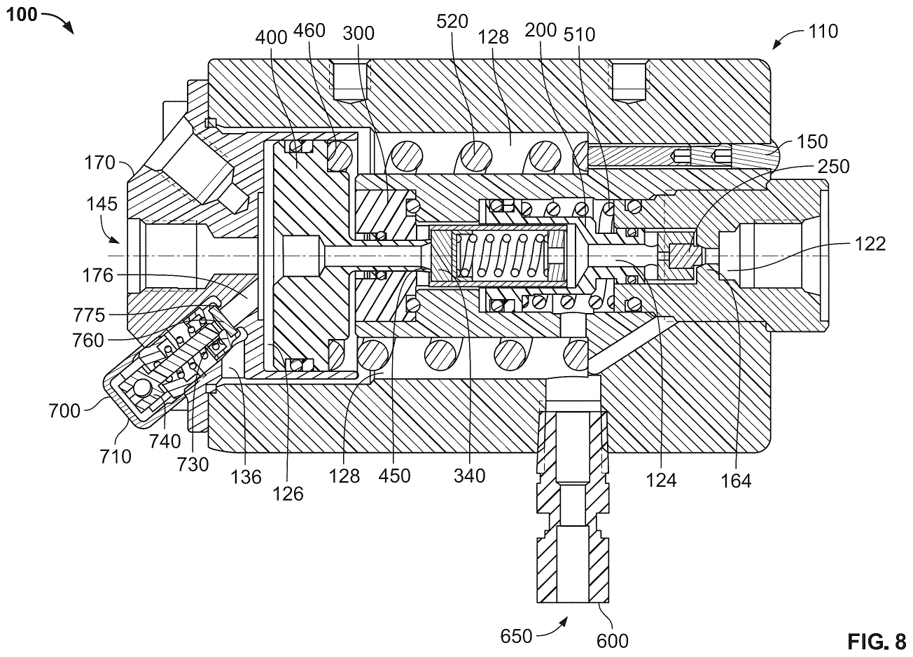

In FIGS. 3-4, piston 200 is rotated relative to seat assembly 300 such that inlet 246 of piston 200 extends radially in a direction that is perpendicular to which outlet 354 of seat assembly 300 extends. In FIGS. 8-13, piston 200 is rotated relative to seat assembly 300 such that inlet 246 of piston 200 extends radially in a direction that is parallel to which outlet 354 of seat assembly 300 extends.

Returning to FIG. 7, piston 200 includes plug 250 that is configured to engage and disengage from valve seat 164 as piston transitions between the first closed position and the first open position, respectively. Plug 250 (also referred to as “first plug,” “first-stage plug,” and “upstream plug”) is coupled to section 220 of piston body 210 at first end 212. Plug 250 has diameter 251 and a corresponding cross-sectional area.

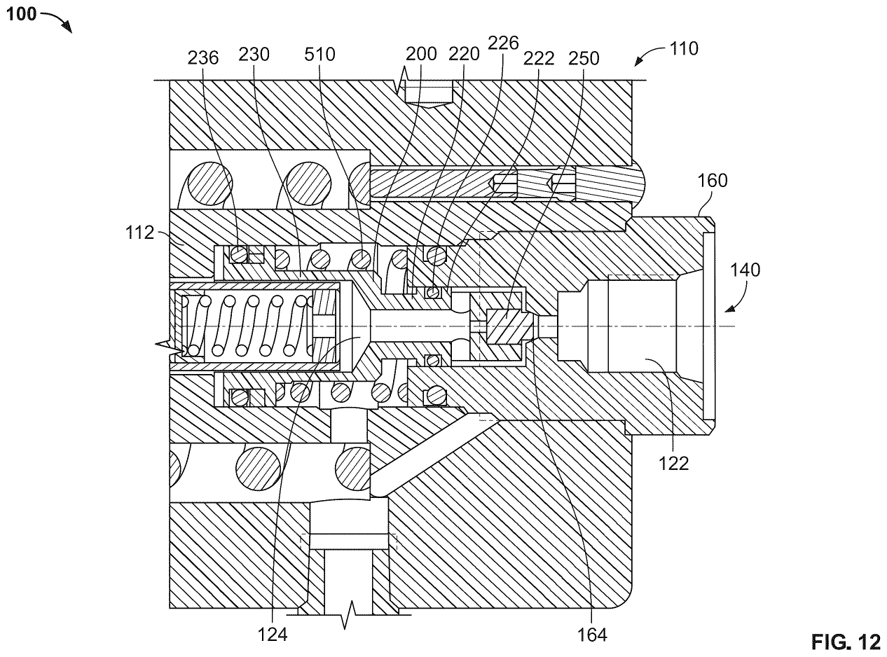

Section 220 of piston body 210 includes flanges 222, 224 that define groove 225. Flange 222 is positioned adjacent inlet 246 such that inlet 246 is positioned axially between plug 250 and flange 222. Flange 222 has diameter 223 and a corresponding cross-sectional area. Seal 226 (e.g., an O-ring) is positioned in groove 225 and, as most clearly shown in FIG. 12, is configured to sealingly engage section 220 and inlet body 160 to form a sealed connection between piston 200 and inlet body 160.

Section 230 of piston body 210 includes flanges 232, 234 that define groove 235. Flange 234 is positioned adjacent second end 214 of piston body 210. Second end 214 has diameter 215 and a corresponding cross-sectional area. Seal 236 (e.g., an O-ring) and washer 238 are positioned in groove 235. As most clearly shown in FIG. 12, seal 236 is configured to sealingly engage section 230 and main body 112 to form a sealed connection between piston 200 and body 110. Washer 238 is configured to securely retain seal 236 in groove 235.

FIG. 8 depicts pressure regulator 100 in a closed state. Piston 200 is in the first closed position and piston 400 is in the second closed position when pressure regulator 100 is in the closed state. That is, when pressure regulator 100 is in the closed state, (1) plug 450 of piston 400 sealingly engages valve seat 340 of seat assembly 300 to fluidly disconnect intermediate section 124 and outlet section 126 and (2) plug 250 of piston 200 sealingly engages valve seat 164 of body 110 to fluidly disconnect inlet section 122 and intermediate section 124.

As shown in FIG. 8, threaded posts 150 extend into and are threadably received by main body. Threaded posts 150 are configured to adjust a biasing force of spring 520. In turn, threaded posts 150 are configured to adjust the predetermined threshold at which piston 400 opens for the second stage of operation of pressure regulator 100. For example, ends of threaded posts 150 extend into vent section 128 of chamber 120 and engage an end of spring 520 opposite spring seat 460. The positioning ends of threaded posts 150 affect a positioning of the end of spring 520, which affects a biasing force of spring 520 that is applied to piston 400.

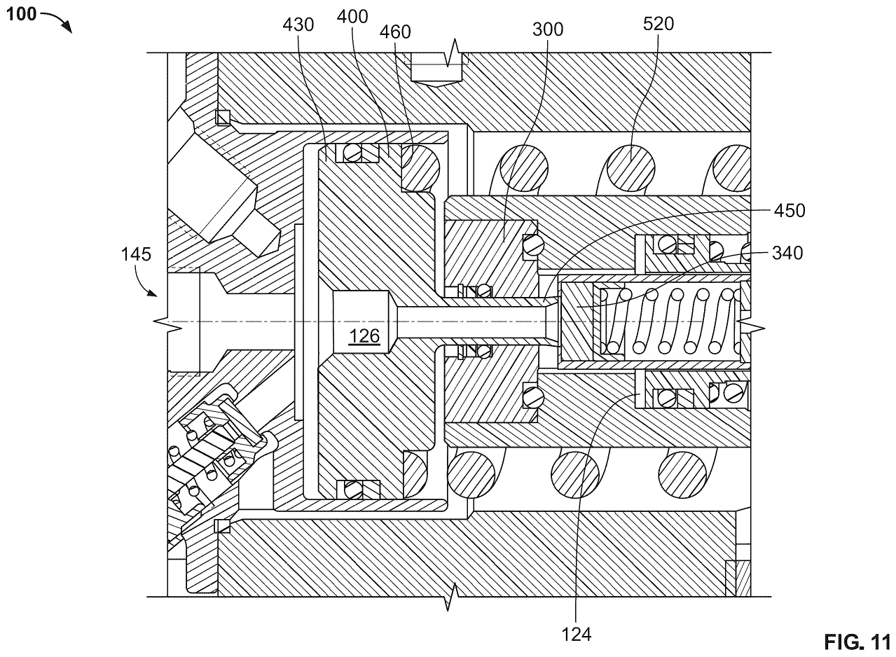

FIGS. 9-10 depict the second stage of pressure regulator 100 in the second closed position. Plug 450 of piston 400 is sealingly engaged to valve seat 340 of seat assembly 300 when the second stage is closed. In turn, outlet section 126 of chamber 120 is fluidly disconnected from intermediate section 124. FIG. 11 depicts the second stage of pressure regulator 100 in the second open position. Plug 450 of piston 400 is sealingly disengaged from valve seat 340 of seat assembly 300 when the second stage is open. In turn, outlet section 126 and intermediate section 124 are fluidly connected.

Piston 400 is configured to be in the second closed position when a second closing force acting on piston 400 is greater than an opposing second opening force acting on piston 400. Piston 400 is configured to transition from the second closed position to the second opening position when the second closing force decreases to a force that is less than the second opening force. Piston 400 is configured to be in the second open position when the second closing force is less than the second opening force. The second closing force is less than the second opening force when the pressure of the fluid in outlet section 126 of chamber 120 is less than a second predefined pressure threshold. Piston 400 is configured to transition from the second open position to the second closed position when the second closing force increases to a force that is greater than the second opening force.

In the illustrated example, the second closing force, F_{2C}, equals P_{D}*A_{2C}. P_{D} equals the pressure of downstream fluid in outlet section 126 of pressure regulator 100. A_{2C} equals the surface area of section 430 of piston 400 as defined by its diameter 432 (FIG. 5).

The second opening force, F_{2O}, equals F_{2S}+F_{2I}. F_{2S} equals the biasing force of spring 520 (also referred to as a “second biasing force” and a “second-stage biasing force”). F_{2I} equals P_{I}*A_{2O}. Prequals the pressure of the fluid in intermediate section 124 of chamber 120. A_{2O} equals the surface area of plug 450 of piston 400 as defined by its diameter 452 (FIG. 5).

In the illustrate example, Far is negligible because the surface area of plug 450 and the pressure in intermediate section 124 are relatively small. In turn, the second opening force, F_{2O}, is substantially equal to F_{2S}, the biasing force of spring 520, such that piston 400 is in the second closed position when F_{2C}>F_{2S} and is in the second open position when F_{2C}<F_{2S}.

In operation, the second stage of pressure regulator 100 is configured to open before the first stage of pressure regulator 100. When piston 400 is in the second open position and piston 200 is in the first closed position, pressure regulator 100 is in an intermediate state.

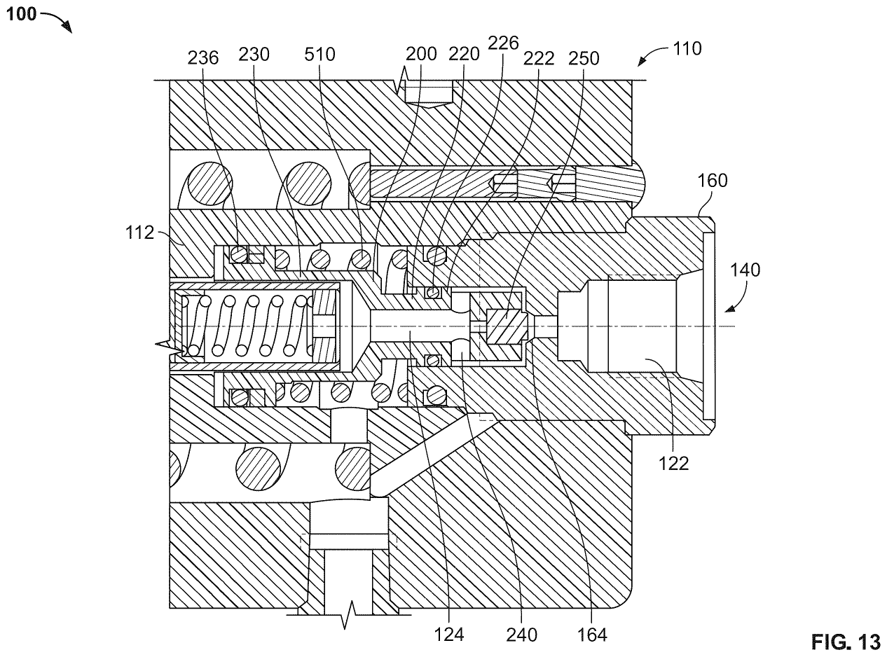

FIG. 12 depict the first stage of pressure regulator 100 in the first closed position. Plug 250 of piston 200 is sealingly engaged to valve seat 164 of body 110 when the first stage is closed. In turn, intermediate section 124 of chamber 120 is fluidly disconnected from inlet section 122. FIG. 13 depicts the first stage of pressure regulator 100 in the first open position. Plug 250 of piston 200 is sealingly disengaged from valve seat 164 of body 110 when the first stage is open. In turn, outlet section 126 and intermediate section 124 are fluidly connected.

In operation, the first stage of pressure regulator 100 is configured to open only when the second stage is already open. When piston 200 is in the first open position and piston 400 is in the second open position, pressure regulator 100 is in an open state that enables compressed gas (e.g., hydrogen) to flow into inlet 140; through inlet section 122, intermediate section 124, and outlet section 126 of chamber 120; and out through outlet 145. Piston 200 is configured to be in the first closed position when a first closing force acting on piston 200 is greater than an opposing first opening force acting on piston 200. Piston 200 is configured to transition from the first closed position to the first opening position when the first closing force decreases to a force that is less than the first opening force. Piston 200 is configured to be in the first open position when the first closing force is less than the first opening force. Piston 200 is configured to transition from the first open position to the first closed position when the first closing force increases to a force that is greater than the first opening force.

The first closing force is less than the first opening force when the pressure of the fluid in intermediate section 124 of chamber 120 is less than a first predefined pressure threshold. The pressure in intermediate section 124 decreases when the first stage of pressure regulator 100 is open. That is, the pressure in intermediate section 124 decreases when piston 400 is in the first open position. In turn, the pressure in intermediate section 124 becomes less than the first predefined pressure threshold after the first stage has been open for a period of time.

In the illustrated example, the first closing force, Fic, equals P_{I}*A_{1C}. P_{I} equals the pressure of fluid in intermediate section 124 of pressure regulator 100. A_{1C} equals the surface area of second end 214 of piston body 210 of piston 200, as defined by its diameter 215 (FIG. 7).

The first opening force, F_{1O}, equals F_{1S}+F_{1I}+F_{1P}. Fis equals the biasing force of spring 510 (also referred to as a “first biasing force” and a “first-stage biasing force”). F_{1I} is an intermediate opening force that acts on piston 200 in intermediate section 124 of chamber 120. F_{1I} equals P_{I}*A_{1F}. Prequals the pressure of the fluid in intermediate section 124 of chamber 120. A_{1F} equals the surface area of section 220 of piston body 210 that sealingly engages body 110, as defined by diameter 223 of flange 222 (FIG. 7). In the illustrated example, A_{1C} is greater than A_{1F} such that Fic is always greater than F_{1I}. F_{1P} is an inlet-side opening force that acts on plug 250 of piston 200 in inlet section 122 of chamber 120. F_{1P} equals P_{P}*A_{1P}. P_{P} equals the pressure of upstream fluid that flows into inlet section 122 of chamber 120. A_{1P} equals the surface area of plug 250 of piston 200, as defined by diameter 251 of plug 250 (FIG. 7).

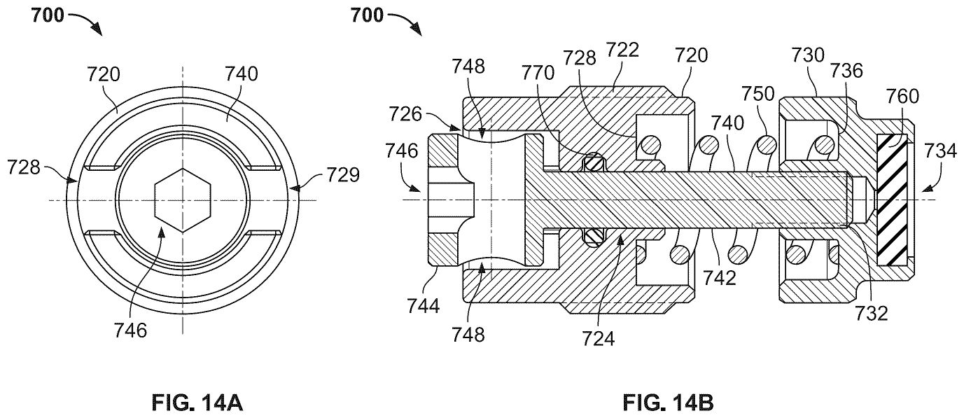

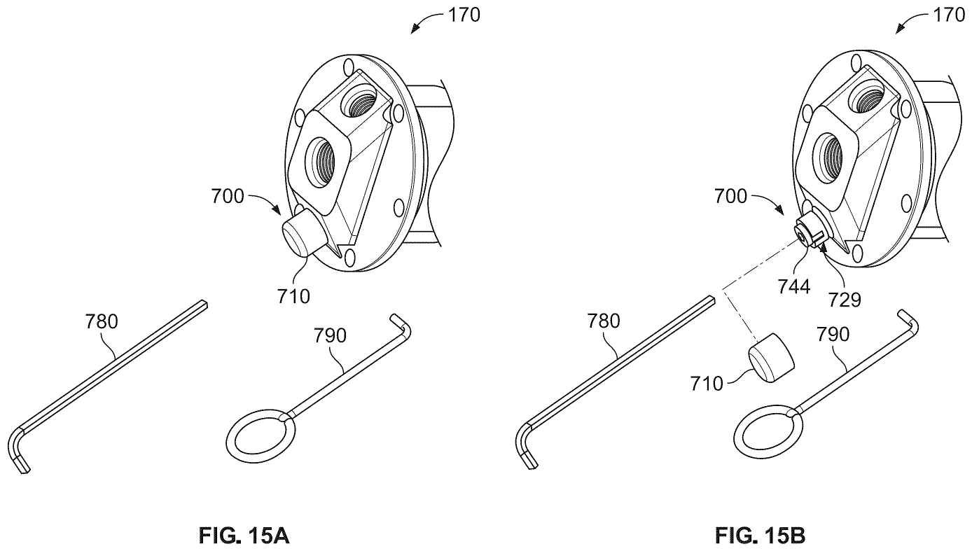

Turning to FIGS. 14A-14B, internal portions of safety relief valve 700 are depicted. Safety relief valve 700 of illustrated example includes fixed body 720, plug body 730, and bolt 740. As illustrated in FIG. 8, safety relief valve 700 also includes cap 710 that couples to outlet body 170 and covers other portions of safety relief valve 700.

Returning to FIGS. 14A-14B, fixed body 720 includes threads 722 to fixedly couple to outlet body 170 of body 110. Fixed body 720 defines a hole 724 that extends along a longitudinal axis of safety relief valve 700. Cavity 726 is defined by a first end of fixed body 720. Spring seat 728 is defined by an opposing second end of fixed body 720.

Plug body 730 includes threads 732 configured to threadably receive a threaded end of shaft 742 of bolt 740 to couple plug body 730 and bolt 740. Plug body 730 is configured to slide as plug 760 of safety relief valve 700 transitions between a closed position and an open position. Plug housing 734 is defined by a first end of plug body 730 and is configured to securely house plug 760. Spring seat 736 is defined by an opposing second end of fixed body 720.

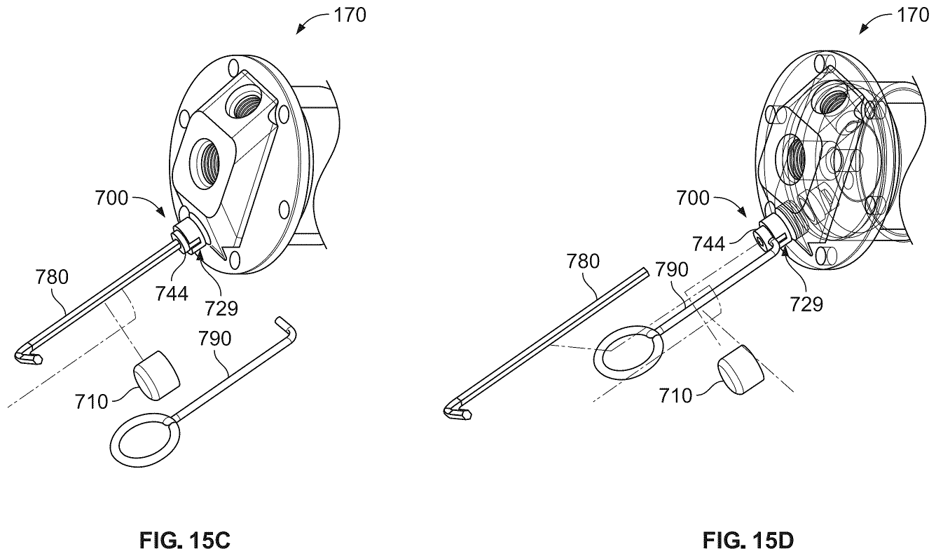

Bolt 740 includes shaft 742 and head 744. Shaft 742 slidably extends through hole 724 of fixed body 720, and the threaded end of shaft 742 is threadably coupled to plug body 730. Safety relief valve 700 includes seal 770 (e.g., an O-ring) to form a sealed connection between shaft 742 of bolt 740 and fixed body 720. An end surface of head 744 of bolt 740 defines keyed opening 746 that is configured to receive keyed tool 780 for manual operation. An outer radial surface of head 744 of bolt defines one or more nested openings 748, each of which is configured to receive hooked tool 790 for manual operation. As disclosed below in greater detail, nested openings 748 are covered by fixed body 720 in a rest position. When bolt 740 is rotated by keyed tool 780, nested openings 748 align with respective one or more slots 729 (shown in FIGS. 14A and 15B-15D) defined by fixed body 720 that enable hooked tool 790 to pull head 744 of bolt 740 at least partially out of cavity 726 of fixed body 720.

Safety relief valve 700 includes spring 750 that extends between and engages spring seat 728 of fixed body 720 and spring seat 736 of plug body 730. Spring 750 extends between and engages fixed body 720 and plug body 730 to bias plug 760 in the closed position against valve seat 775. Spring 750 is expanded when plug 760 is in the closed position, and spring 750 is compressed when plug 760 is in the open position.

Returning briefly to FIG. 8, valve seat 775 is defined by outlet body 170 of body 110. When plug 760 of safety relief valve 700 is sealingly engaged with valve seat 775 in the closed position, relief pathway 176 is fluidly disconnected from vent pathway 136 such that outlet section 126 of chamber 120 is fluidly disconnected from vent section 128.

When plug 760 is disengaged from valve seat 775 in the open position, relief pathway 176 is fluidly connected from vent pathway 136 such that outlet section 126 is fluidly connected from vent section 128. In turn, compressed gas is able to flow from outlet section 126, to vent section 128, and out through vent 650. Safety relief valve 700 is configured to open when pressure within outlet section 126 is greater than a predetermined threshold. By opening and directing some compressed gas into vent section 128 and out through vent 650, safety relief valve 700 is able to reduce the downstream pressure to be less than the predetermined threshold. Safety relief valve 700 also is configured to be opened manually. An operator may elect to manually open safety relief valve 700 to reduce the downstream pressure.

FIGS. 15A-15D depicts a sequence of manually opening safety relief valve 700.

Keyed tool 780 and hooked tool 790 are used to manually open safety relief valve 700.

FIG. 15A depicts safety relief valve 700 in a resting state. Cap 710 is coupled to outlet body 170 and covers other portions of safety relief valve 700. FIG. 15B depicts safety relief valve 700 when cap 710 has been removed from outlet body 170 to expose head 744 of bolt 740 and slots 729 of fixed body 720. FIG. 15C depicts safety relief valve 700 as keyed tool 780 is inserted into keyed opening 746 (FIG. 14A) of head 744 and rotates bolt 740 to align nested openings 748 (FIG. 14B) of head 744 of bolt 740 and slots 729 of fixed body 720. FIG. 15D depicts safety relief valve 700 after hooked tool 790 has extended through one of slots 729, been inserted into one of nested openings 749 of head 744 of bolt 740, and pulled head 744 of bolt 740 in an axially outward direction. Plug 760 disengages from valve seat 775 to open safety relief valve 700 when bolt 740 is pulled outward. Upon release, spring 750 (FIG. 14B) is configured to bias plug 760 back to the closed position.

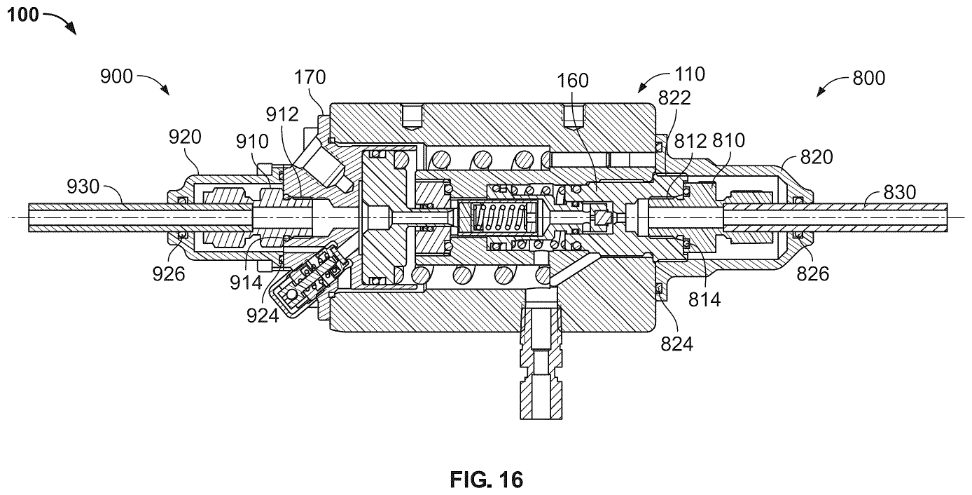

FIG. 16 depicts pressure regulator 100 with sealing cap 800 (also referred to as “inlet sealing cap” and “inlet-side sealing cap”) and sealing cap 900 (also referred to as “outlet sealing cap” and “outlet-side sealing cap”). Sealing cap 800 is configured to (1) collect any gas that may leak from the connection formed between piping 830 and pressure regulator 100 and (2) redirect the collected gas to vent 650. Sealing cap 900 is configured to (1) collect any gas that may leak from the connection formed between piping 930 and pressure regulator 100 and (2) redirect the collected gas to vent 650.

Sealing cap 800 includes inner body 810 and outer body 820. Inner body 810 is coupled to inlet body 160 via threads 812. Sealing cap 800 includes seal 814 (e.g., an O-ring) to form a sealed connection between inner body 810 and inlet body 160. Outer body 820 is coupled to inlet body 160 via threads 822. Sealing cap 800 includes seal 824 (e.g., an O-ring) to form a sealed connection between outer body 820 and body 110. Piping 830 (also referred to as “inlet-side piping”) is configured to extend into outer body 820 and be securely received by inner body 810. Sealing cap 800 includes seal 826 (e.g., an O-ring) to form a sealed connection between outer body 820 and piping 830.

Sealing cap 900 includes inner body 910 and outer body 920. Inner body 910 is coupled to outlet body 170 via threads 912. Sealing cap 900 includes seal 914 (e.g., an O-ring) to form a sealed connection between inner body 910 and outlet body 170. Outer body 920 is coupled to outlet body 170. Sealing cap 900 includes seal 924 (e.g., an O-ring) to form a sealed connection between outer body 920 and outlet body 170. Piping 930 (also referred to as “outlet-side piping”) is configured to extend into outer body 920 and be securely received by inner body 910. Sealing cap 900 includes seal 926 (e.g., an O-ring) to form a sealed connection between outer body 920 and piping 930.

An example two-stage pressure regulator includes a body defining an inlet, an outlet, and a chamber extending between the inlet and the outlet. The chamber includes an inlet section, an intermediate section, and an outlet section. The body includes an upstream valve seat adjacent the inlet. The two-stage pressure regulator includes an upstream piston slidably positioned in the chamber adjacent the inlet to separate the inlet section and the intermediate section of the chamber. The upstream piston includes a first plug that is configured to engage the upstream valve seat in a first closed position. The first plug is configured to be disengaged from the upstream valve seat in a first open position to enable compressed gas to flow from the inlet section and to the intermediate section. The two-stage pressure regulator includes a seat assembly housed in the chamber and fixed to the body. The seat assembly includes a downstream valve seat. The two-stage pressure regulator includes a downstream piston slidably positioned in the chamber adjacent the outlet to separate the intermediate section and the outlet section of the chamber. The downstream piston includes a second plug that is configured to engage the downstream valve seat in a second closed position. The second plug is configured to be disengaged from the downstream valve seat in a second open position to enable the compressed gas to flow from the intermediate section and to the outlet section.

In some examples, the seat assembly further includes a first end and a second end. The first end is received by a first opening of the upstream piston. The second end defines a second opening that is configured to slidably receive the downstream piston.

In some examples, the seat assembly further includes a seat spring that is configured to press the downstream valve seat in place. The seat spring is configured to compress when the second plug engages the downstream valve seat to reduce wear on the downstream valve seat.

In some examples, the inlet section extends from the inlet to the upstream valve seat, the intermediate section extends from the upstream valve seat to the downstream valve seat, and the outlet section extends from the downstream valve seat to the outlet.

In some examples, the seat assembly defines one or more holes adjacent the downstream valve seat. The one or more holes fluidly connect the intermediate section and the outlet section when the downstream piston is disengaged from downstream valve seat in the first open position.

In some examples, the body, the upstream piston, and the seat assembly define the intermediate section of the chamber.

Some examples further include a first spring extending between and engaging the upstream piston and the body to bias the upstream piston to the first open position.

In some examples, the upstream piston is configured to be in the first open position when a first closing force is less than a first opening force. The first opening force is formed by a combination of a first biasing force of a first spring, an inlet-side opening force acting on the first plug in the inlet section of the chamber, and an intermediate opening force acting on the upstream piston in the intermediate section of the chamber. In some such examples, the upstream piston is configured to be in the first closed position when the first closing force is greater than or equal to the first opening force. In some such examples, the upstream piston is configured to transition from the first closed position to the first open position when downstream use of the compressed gas causes pressure in the intermediate section of the chamber to decrease to less than a first predefined pressure threshold. The first closing force is less than the first opening force when the pressure in the intermediate section is less than the first predefined pressure threshold. In some examples, the upstream piston further includes a piston body having a first section and a second section. The upstream piston is positioned such that the first closing force is to act on the second section and the intermediate opening force is to act on the first section. The second section has a larger cross-sectional area than that of the first section such that the first closing force is greater than the intermediate opening force.

In some examples, the upstream piston further includes a first piston body that includes a first section and a second section. The first plug is coupled to the first section of the of first piston body. Some such examples further include a first seal. The first piston body further includes a first flange that is adjacent the first seal and the first section of the first piston body. The first seal is configured to slidably and sealingly engage the body to sealingly separate the inlet section and the intermediate section of the chamber. Some such examples further include a second seal. The first piston body further includes a second flange at the second section and adjacent the second seal. The second seal is configured to slidably and sealingly engage the body to sealingly separate the intermediate section and the outlet section of the chamber. Additionally, some such examples further include a first spring extending between and engaging the second flange and the body to bias the upstream piston to the first open position.

Some examples further include a second spring that engages the downstream piston to bias the downstream piston to the second open position. Some such examples further include threaded shafts that engage an end of the second spring opposite the downstream piston. The threaded shafts are configured to adjust a second biasing force of the second spring. In some such examples, the downstream piston is configured to be in the second open position when a second closing force is less than a second opening force. The second opening force is substantially equal to a second biasing force of the second spring. Additionally, in some such examples, the downstream piston is configured to transition from the second closed position to the second open position when downstream use of the compressed gas causes pressure in the outlet section of the chamber to decrease to less than a second predefined pressure threshold. The second closing force is less than the second opening force when the pressure in the outlet section is less than the second predefined pressure threshold. In some such examples, the downstream piston is configured to be in the second closed position when a second closing force is greater than or equal to a second opening force.

In some examples, the downstream piston is configured to be in the second open position when an outlet pressure in the outlet section is less than a second predefined pressure threshold; the upstream piston is configured to be in the first open position when an intermediate pressure in the intermediate section is less than a first predefined pressure threshold; and the downstream piston and the upstream piston are configured to permit the compressed gas to flow into the inlet, through the chamber, and out of the outlet when the downstream piston is in the second open position and the upstream piston is in the first open position.

In some examples, the downstream piston further includes a second piston body that defines the second plug.

In some examples, the chamber further includes a vent section. The body further defines a vent fluidly connected to the vent section. The vent section and the vent are arranged to vent any of the compressed gas that leaks from the inlet section, the intermediate section, and the outlet section. Some such examples further include a safety relief valve that is configured to fluidly disconnect the vent section from the outlet section in a respective closed position and fluidly connect the vent section to the outlet section in a respective open position. The safety relief valve is configured to open when pressure in the outlet section is greater than a predefined pressure threshold. The safety relief valve is configured to open manually. Some such examples further include an inlet-side sealing cap that is configured to redirect any of the compressed gas that leaks from a connection with inlet-side piping to the vent and an outlet-side sealing cap that is configured to redirect any of the compressed gas that leaks from a connection with outlet-side piping to the vent.

In some examples, the body includes a main body, an inlet body that is coupled to the main body and defines the inlet and the upstream valve seat, and an outlet body that is coupled to the main body and defines the outlet.

Some examples further include a sensor coupled to the body and fluidly connected to the outlet section of the chamber.

1. A two-stage pressure regulator, comprising:
a body defining an inlet, an outlet, and a chamber extending between the inlet and the outlet, wherein the chamber includes an inlet section, an intermediate section, and an outlet section, and wherein the body includes an upstream valve seat adjacent the inlet;
an upstream piston slidably positioned in the chamber adjacent the inlet to separate the inlet section and the intermediate section of the chamber, wherein the upstream piston includes a first plug that is configured to engage the upstream valve seat in a first closed position, and wherein the first plug is configured to be disengaged from the upstream valve seat in a first open position to enable compressed gas to flow from the inlet section and to the intermediate section;
a seat assembly housed in the chamber and fixed to the body, wherein the seat assembly includes a downstream valve seat; and
a downstream piston slidably positioned in the chamber adjacent the outlet to separate the intermediate section and the outlet section of the chamber, wherein the downstream piston includes a second plug that is configured to engage the downstream valve seat in a second closed position, and wherein the second plug is configured to be disengaged from the downstream valve seat in a second open position to enable the compressed gas to flow from the intermediate section and to the outlet section.

2. The two-stage pressure regulator of claim 1, wherein the seat assembly further includes a first end and a second end, wherein the first end is received by a first opening of the upstream piston, and wherein the second end defines a second opening that is configured to slidably receive the downstream piston.

3. The two-stage pressure regulator of claim 1, wherein the seat assembly further includes a seat spring that is configured to press the downstream valve seat in place, wherein the seat spring is configured to compress when the second plug engages the downstream valve seat to reduce wear on the downstream valve seat.

4. The two-stage pressure regulator of claim 1, wherein the inlet section extends from the inlet to the upstream valve seat, the intermediate section extends from the upstream valve seat to the downstream valve seat, and the outlet section extends from the downstream valve seat to the outlet.

5. The two-stage pressure regulator of claim 1, further comprising a first spring extending between and engaging the upstream piston and the body to bias the upstream piston to the first open position.

6. The two-stage pressure regulator of claim 1, wherein the upstream piston is configured to be in the first open position when a first closing force is less than a first opening force, wherein the first opening force is formed by a combination of a first biasing force of a first spring, an inlet-side opening force acting on the first plug in the inlet section of the chamber, and an intermediate opening force acting on the upstream piston in the intermediate section of the chamber.

7. The two-stage pressure regulator of claim 6, wherein the upstream piston is configured to transition from the first closed position to the first open position when downstream use of the compressed gas causes pressure in the intermediate section of the chamber to decrease to less than a first predefined pressure threshold, wherein the first closing force is less than the first opening force when the pressure in the intermediate section is less than the first predefined pressure threshold.

8. The two-stage pressure regulator of claim 6, wherein the upstream piston further includes a piston body having a first section and a second section, wherein the upstream piston is positioned such that the first closing force is to act on the second section and the intermediate opening force is to act on the first section, and wherein the second section has a larger cross-sectional area than that of the first section such that the first closing force is greater than the intermediate opening force.

9. The two-stage pressure regulator of claim 1, further comprising a second spring that engages the downstream piston to bias the downstream piston to the second open position.

10. The two-stage pressure regulator of claim 9, further comprising threaded shafts that engage an end of the second spring opposite the downstream piston, wherein the threaded shafts are configured to adjust a second biasing force of the second spring.

11. The two-stage pressure regulator of claim 9, wherein the downstream piston is configured to be in the second open position when a second closing force is less than a second opening force, wherein the second opening force is substantially equal to a second biasing force of the second spring.

12. The two-stage pressure regulator of claim 11, wherein the downstream piston is configured to transition from the second closed position to the second open position when downstream use of the compressed gas causes pressure in the outlet section of the chamber to decrease to less than a second predefined pressure threshold, wherein the second closing force is less than the second opening force when the pressure in the outlet section is less than the second predefined pressure threshold.

13. The two-stage pressure regulator of claim 1, wherein:
the downstream piston is configured to be in the second open position when an outlet pressure in the outlet section is less than a second predefined pressure threshold;
the upstream piston is configured to be in the first open position when an intermediate pressure in the intermediate section is less than a first predefined pressure threshold; and
the downstream piston and the upstream piston are configured to permit the compressed gas to flow into the inlet, through the chamber, and out of the outlet when the downstream piston is in the second open position and the upstream piston is in the first open position.

14. The two-stage pressure regulator of claim 1, wherein the chamber further includes a vent section, wherein the body further defines a vent fluidly connected to the vent section, and wherein the vent section and the vent are arranged to vent any of the compressed gas that leaks from the inlet section, the intermediate section, and the outlet section.

15. The two-stage pressure regulator of claim 14, further comprising a safety relief valve that is configured to fluidly disconnect the vent section from the outlet section in a respective closed position and fluidly connect the vent section to the outlet section in a respective open position, wherein the safety relief valve is configured to open when pressure in the outlet section is greater than a predefined pressure threshold, and wherein the safety relief valve is configured to open manually.

16. The two-stage pressure regulator of claim 14, further comprising:
an inlet-side sealing cap that is configured to redirect any of the compressed gas that leaks from a connection with inlet-side piping to the vent; and
an outlet-side sealing cap that is configured to redirect any of the compressed gas that leaks from a connection with outlet-side piping to the vent.

17. A two-stage pressure regulator, comprising:
a body defining an inlet, an outlet, and a chamber extending between the inlet and the outlet, wherein the chamber includes an inlet section, an intermediate section, and an outlet section, and wherein the body includes an upstream valve seat adjacent the inlet;
an upstream piston slidably positioned in the chamber adjacent the inlet to separate the inlet section and the intermediate section of the chamber, wherein the upstream piston includes a first plug that is configured to engage the upstream valve seat in a first closed position, and wherein the first plug is configured to be disengaged from the upstream valve seat in a first open position to enable compressed gas to flow from the inlet section and to the intermediate section;
a seat assembly partially nested in the upstream piston and comprising a downstream valve seat; and
a downstream piston partially nested in the seat assembly and slidably positioned adjacent the outlet to separate the intermediate section and the outlet section of the chamber, wherein the downstream piston includes a second plug that is configured to engage the downstream valve seat in a second closed position, and wherein the second plug is configured to be disengaged from the downstream valve seat in a second open position to enable the compressed gas to flow from the intermediate section and to the outlet section.

18. The two-stage pressure regulator of claim 17, wherein:
the downstream piston is configured to be open when an outlet pressure in the outlet section is less than a first predefined pressure threshold;
the upstream piston is configured to be open when an intermediate pressure in the intermediate section is less than a second predefined pressure threshold; and
the downstream piston and the upstream piston are configured to permit the compressed gas to flow into the inlet, through the chamber, and out of the outlet when the downstream piston and the upstream piston are open.

19. The two-stage pressure regulator of claim 17, further comprising a first seal and a second seal, wherein the first seal is configured to slidably and sealingly engage the body to sealingly separate the inlet section and the intermediate section of the chamber, and wherein the second seal is configured to slidably and sealingly engage the body to sealingly separate the intermediate section and the outlet section of the chamber.

20. The two-stage pressure regulator of claim 17, wherein the seat assembly further includes a first end and a second end, wherein the first end is received by a first opening of the upstream piston, and wherein the second end defines a second opening that is configured to slidably receive the downstream piston.

21. The two-stage pressure regulator of claim 20, wherein the body, the upstream piston, and the seat assembly define the intermediate section of the chamber.
